(19) United States
(12) Patent Application Publication
(10) Pub. No.: US 2022/0383680 A1
(43) Pub. Date: Dec. 1, 2022

(54) TOUCHLESS SMART STORAGE BOX WITH FACE RECOGNITION SYSTEM

(71) Applicant: TULSIDAS, Luv, Ridgewood, NJ (US)

(72) Inventor: Luv Tulsidas, Ridgewood, NJ (US)

(21) Appl. No.: 17/775,157

(22) PCT Filed: Nov. 6, 2020
(86) PCT No.: PCT/US20/59471

§ 371 Date: May 6, 2022

Related U.S. Application Data
(60) Provisional application No. 62/931,959, filed on Nov. 7, 2019.

(51) Int. Cl. G07C 9/00; E05G 1/10; G06V 40/16; G07C 9/37

(52) U.S. Cl. CPC G07C 9/00912; E05G 1/10; G06V 40/172; G07C 9/37

(57) ABSTRACT

A touchless smart storage box is presented for storage of items like documents, jewellery, data discs, currency, handgun, firearms, etc. The box conducts the authentication for access thereto based on facial information of the user. Once the facial information matches, the contents of the box are made visible on the screen associated with the box by means of an internal camera. A motor may be used to open and close the door without any physical interaction. Multiple sensors may be embedded onto the smart box to indicate its status of open close and location. Due to tempering action the camera may get triggered to capture the scenario and transmit the same to mobile and web application. Communication protocol enables the box to be operated remotely for all interactions.

### CROSS-REFERENCE TO RELATED APPLICATIONS

This application claims the benefit of U.S. Provisional Patent Application No. 62/931,959, filed Nov. 7, 2019, which is incorporated by reference herein in its entirety.

### FIELD OF INVENTION

The present application relates to a system and method for controlling access to unmanned storage compartments using facial recognition. The present application further relates to storage devices for the safe and secure storage of valuable items.

### BACKGROUND OF THE INVENTION

Methods and apparatus for securely storing items are an essential requirement for individuals and companies to protect their valuable assets against, e.g., man-created and natural perils, i.e., fire, heat, humidity, tampering, theft, and the like. Traditionally, tangible protection is provided by containers (boxes) made of metallic and/or polymer materials which are designed with sufficient mechanical, metallurgical, and physical characteristics, such as strength and storage volume, to serve the intended purpose.

These boxes are equipped with at least one lock having a corresponding key that restricts access to the content thereof to authorized users; hence, every time an authorized user needs to gain access to the contents of the box, the user must carry and/use the specified key to unlock and open the box and, then, to close and lock the box. It is not possible to access and secure these types of boxes, e.g., open or close/lock or unlock, remotely or otherwise touchless. Even if the box is opened using a smart card, for example, the card must be carried physically for every interaction. In currently existing boxes, autonomous and/or hands-free operation is not possible.

Numerous safe storage boxes exist, including rectangular boxes with a lid, rectangular sliding draw, side opening door, sliding door, gravity falling door, etc. The majority of these designs have a handle to facilitate the operation of closing and opening using one hand or both. Hence remote operation of these boxes can be a challenge.

Safe storage systems also exist which can provide a storage space by means of multiple plates for bottom, top, side, and rear walls. A door is attached to the box frame typically with a swing mechanism. Usually, user interaction with the box is manual, i.e., requiring the use of one or both the hands for opening and closing. If both the hands are needed for carrying the items to be stored therein, however, it becomes difficult to use this type of box.

Prior boxes also include a design of a storage box which has a rigid base plate extending forwardly, along with a door mechanism to close and open the box. The door is typically hinged at the bottom of the frame, which once unlocked falls downward due to gravity. This type does not require manual effort to open the box, but human effort is needed for closing and locking. If the user is carrying articles in both hands, closing the box becomes difficult.

There also exist storage boxes with a glass window embedded onto one of the side walls of the box. The glass window allows one to look into the box and to know the presence or absence of its content, but this kind of arrangement is not suitable for changing users and the content thereof still cannot be viewed remotely for the purpose of monitoring and/or managing multiple storage spaces, for example.

In places like sports facilities, temples, movie theatres, and shopping malls, multiple people may want to access the storage box provided temporarily multiple times during a day. In this scenario, there will be significant time consumed leading to unnecessary delay and forming large gatherings of people in usually small spaces where lockboxes are located. Traditional boxes cannot change the access privileges dynamically or to provide such privileges to multiple people for that temporary storage of articles in a way that is seamless and/or hassle free.

Some storage boxes are equipped with bar code or use RFID card readers for the purpose of identification, but this cannot be used to locate the box, if the box is moved from place of storage to other areas by unauthorized users.

Finally, safe deposit boxes with a digital panel, which uses a numeric passcode for authorizing the user are also known. This kind of design has drawbacks, including the probable mistyping of the digit due to forgetfulness of the user. There is also a probability of cracking the passcode by permutations and combinations by unauthorised users.

In a majority if not all these boxes, the status of open and close position of the door is not known hence cannot be closed or opened remotely.

In view of the obvious shortcomings of the above and overall review of currently available models and methods for safe storage of valuable items, it is evident that there is a need for an autonomous safe storage container which can be operated in fully autonomous mode without human touch.

The present application obviates or otherwise ameliorates the limitations noted above by providing an apparatus and corresponding method for controlling access to and/or the opening and closing of the apparatus using face recognition, and more particularly, to an apparatus and corresponding method for controlling access to and/or the opening and closing of an unmanned storage box using facial recognition, or other biometric identification, preferably remotely.

### SUMMARY OF THE INVENTION

It is an object of at least one embodiment of the present invention to provide a system and method for safe storage with touchless interaction with a storage box. The method further may be used for controlling opening and closing of an unattended storage box using face recognition capable of controlling opening and closing of an unattended storage box provided in a door as well as a door lock using a face recognition function.

According to an aspect of the present invention, there is a system for smart storage boxes that includes multiple sensors and communication protocols, for example Wi-Fi, NFC, Bluetooth. GPRS/mobile connectivity through SIM card for remote control and for sending alerts. Smart Box may also be embedded with a baroscopic or similar camera with LED light.

According to another aspect of the present invention, there is a system provided for face recognition module that includes an edge camera communicatively connected to a processor storing a facial recognition algorithm with features like spoof detection. The face recognition module preferably interacts with cloud databases for web and mobile interaction.

According to another aspect of the present invention, there is a system provided for an automatic door opening module that includes an electric hub motor supported in a circular cylinder for autonomous opening and closing operation of the box door. It is to be understood that the automatic door opening model may include other mechanisms and elements that are configured to open or/and close the door of the box automatically.

According to another aspect of the present invention, there is provided a system for web or mobile modules that includes a computer program, which, when executed, enables remote operation of a safe box.

According to another aspect of the present invention, there is provided a system for controlling unlocking, opening, closing, and/or locking of an unmanned storage box using face recognition, the apparatus includes: a camera unit for capturing a face image of a shipper; an authentication unit for performing face authentication by comparing a photographed image photographed by a camera with a face image stored in an authentication database; a touch screen for receiving input of a delivery person in a touch manner so that the delivery person can communicate with the recipient terminal; a communication unit that communicates with a recipient via a wire/wireless communication network and receives an open or open refusal signal of the unattended storage as an open control signal; and controlling the unattended storage to be opened when the facial image is authenticated or when receiving the open control signal from the recipient terminal.

The invention may further include a management server storing an authentication database for face authentication. Also, when the face image is not authenticated, a screen for a call connection or text transmission is displayed to the recipient terminal via the touch screen. Further, an infrared temperature sensor is additionally provided in the unattended storage box. In addition, when a signal is generated from the infrared temperature sensor, the unattended storage box can be immediately closed. The authentication unit compares the image photographed by the camera with a plurality of facial images stored in the authentication DB to perform authentication, and performs authentication by first comparing facial images at a time zone corresponding to the input time of the photographed image.

According to another aspect of the present invention, there is provided a method for controlling opening and closing of an unmanned storage box using face recognition, the method comprising: Performing face authentication in comparison with an image; and controlling the control unit to open the unattended storage box when the facial image is authenticated. In addition, when the face image is not authenticated, the delivery person may be allowed to input the delivery person input in a touch manner so that the delivery person can communicate with the recipient terminal.

According to another aspect of the present invention, there is provided a method for the communicating unit to communicate with the receiver and the receiver through a wired or wireless communication network to receive an open or open reject signal of the unattended storage as an open control signal; and controlling the control unit to open the unattended storage box when receiving the open control signal from the recipient terminal.

In addition, the authentication unit may perform face authentication using the face image from the authentication database for face authentication stored in the remote management server. Also, when the face image is not authenticated, a screen for a call connection or text transmission may be displayed to the recipient terminal via the touch screen.

According to another aspect of the present invention, there is provided a method for the authentication unit comparing the image photographed by the camera with a plurality of facial images stored in the authentication DB to perform authentication, and performs authentication by first comparing facial images at a time zone corresponding to the input time of the photographed image.

According to at least one aspect of the present invention, not only the opening and closing of a general door lock but also the opening and closing of the unattended storage box provided in the groove are controlled by using the face recognition function, thereby providing the user with convenience. Since the unattended storage box is opened and closed by face authentication, there is an effect that the risk of loss of the article to be delivered can be prevented in advance.

### BRIEF DESCRIPTION OF DRAWINGS

The subject matter disclosed may best be understood by reference to the following detailed description when read with the accompanying drawings in which:

FIG. 1 is schematic view of a typical configuration of Smart Storage Box according to a preferred embodiment;

FIG. 2 is schematic view of flow chart of system operation according to a preferred embodiment;

FIG. 3 is schematic view of arrangement of sensors according to a preferred embodiment;

FIG. 4 is schematic view working of automatic door opening according to a preferred embodiment;

FIG. 5 is schematic view web or mobile interface according to a preferred embodiment;

FIG. 6 is a view schematically showing a configuration for performing opening and closing control of an unattended storage box using face recognition according to at least one embodiment of the present invention;

FIG. 7 is a block diagram showing the configuration of an unattended storage box opening or closing control apparatus using face recognition according to an embodiment of the present invention;

FIG. 8 is a flowchart illustrating an authentication process according to at least one embodiment of the present invention;

FIG. 9 is a flowchart illustrating an open/close control method of an unattended storage box using face recognition according to at least one embodiment of the present invention; and

FIG. 10 is a block diagram illustrating one of an implementation of the present invention.

### DETAILED DESCRIPTION OF PREFERRED EMBODIMENT

Hereinafter, an embodiment of the present invention will be described in detail with reference to exemplary drawings. It should be noted that, in adding reference numerals to the constituent elements of the drawings, the same constituent elements are denoted by the same reference symbols as possible even if they are shown in different drawings. In the following description of the present invention, a detailed description of known functions and configurations incorporated herein will be omitted when it may make the subject matter of the present invention rather unclear.

Furthermore, in describing the components of the present invention, when a component is described as being “connected”, “coupled” or “connected” to another component, the component may be directly connected to the other component It should be understood that another component may be “connected”, “coupled”, or “connected” between each component.

Generally, the unattended storage box is any type of storage box provided, for example, at the front door of a residence and including a free space for storing a package or the like therein, and may include a door that is configured for opening and closing of the door, and a password key for inputting a password for unlocking the door. Other means for accessing the box may also be used. Herein, the unattended storage box may be provided at the front door, but the present invention is not limited thereto, and it is of course possible to provide the unattended storage box at various other places such as a common entrance or a location with a security guard.

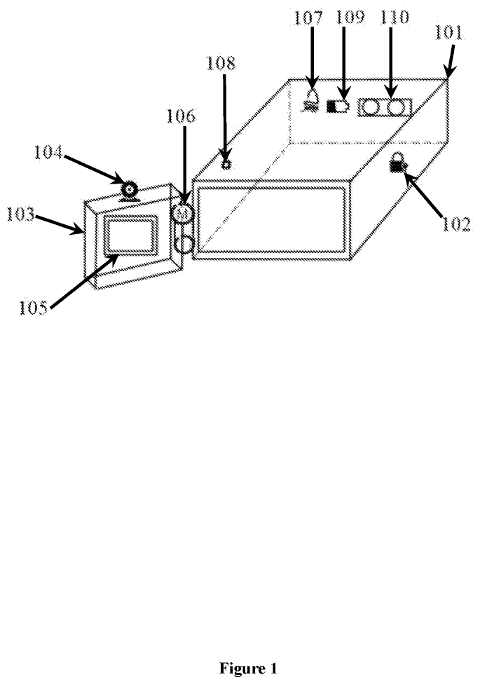

The presented application provides a method and apparatus for storing, monitoring, and managing valuable items. As depicted in FIG. 1, the device consists of a container 101 with a hollow space therein for storing articles, a lock 102, a door 103, an external camera 104, a digital display 105, a hub motor 106, an internal camera 107, a processor 108, a plurality of sensors 109, and/or a power source 110. The device preferably includes computer memory that stores a computer program thereon that when executed performs or enables the functions disclosed herein.

Door 103 is preferably equipped with a lock 102, which locks and unlocks to selectively provide access to the space therein. The device may include an external camera 104 and a display 105, preferably on the front of the door 103. Door 103 may be hinged and/or removably connected to a hub motor 106 and to container 101. Lock 102 is preferably configured to be used in manual mode operation and automated mode for remote operation. Each of the plurality of sensors 109 may be communicatively connected to at least one indicator displayed by digital display 105. One of the plurality of sensors 105 may be a GPS sensor, which determines the location of the apparatus which may be used for authentication as discussed herein. One other of the plurality of sensors 105 may be a power reserve indicator, which indicates whether the device is on a/c and/or reserve power.

The operation of apparatus depicted in FIG. 1 is preferably controlled by a computer program or code executed by the processor 108. The code when executed performs a method of operation that includes the steps of detecting, by the external camera 104, the proximity of a user to the container 101, capturing, by external camera 104, an image containing facial features of the user, storing the captured facial image of the user in a memory communicatively connected to processor 108, comparing the captured facial image of the user with facial images stored in the memory to determine whether the memory contains a previously obtained facial image of the user.

If a determination is made that the captured facial image of the user is identical or sufficiently identical to the stored facial image of the user, an appropriate authentication message may be displayed on the digital monitor 105.

If the identity of the user is positively authenticated, the user may be provided with an interface screen on the display 105 or another device that allows the user to execute a command, for example, to view the content of the container 101 by invoking functionality of internal camera 107 to capture images of a compartment of container 101. Images captured by internal camera 107 may be displayed on digital display 105 for the user to view, as if having opened the door 102. It is to be understood that the images captured by internal camera 107 may be also transmitted to a user's other electronic device, e.g., computer, smartphone, and the like. In this instance, authentication may also be achieved with the user's device. In this iteration, the device 100 includes a communication module that transmits messages and/or other information to a remote device, either directly or over a communication network.

If the user wishes to access the contents of container 101, the user may in be provided with an interface screen that allows the user to send to the system a command to unlock the lock 102 and/or to open the door 103. Upon detecting the command from the user to unlock the lock 102, processor 108 executes a computer program that sends a signal to hub motor 106 to unlock lock 102 and/or to open the door 103, as the case may be, automatically.

Once the user approaches the safe box, the camera 106 captures the facial features of the user and stores the images locally in a memory associated with edge processor 108, which further compares the facial image with stored images. Once the user is authenticated the same will preferably be displayed in display 105. If the user wants to check the presence or absence of the articles without opening the door 103, a signal caused by the user selecting an appropriate button on a touchscreen or automatically without user intervention may trigger the internal camera 107 to operate. The internal camera which is preferably equipped with an LED to illuminate the interior of the container transmits images of contents to the display device. The same can be viewed from a remote location using a mobile application 503. Once the status is known, the user can choose to open the door for accessing the articles or can conclude the interaction with the box by simply walking away. After the contents are taken hub motor gets triggered to close the door automatically, for example, when the device determines that the user is no longer in the field of view of the camera 104.

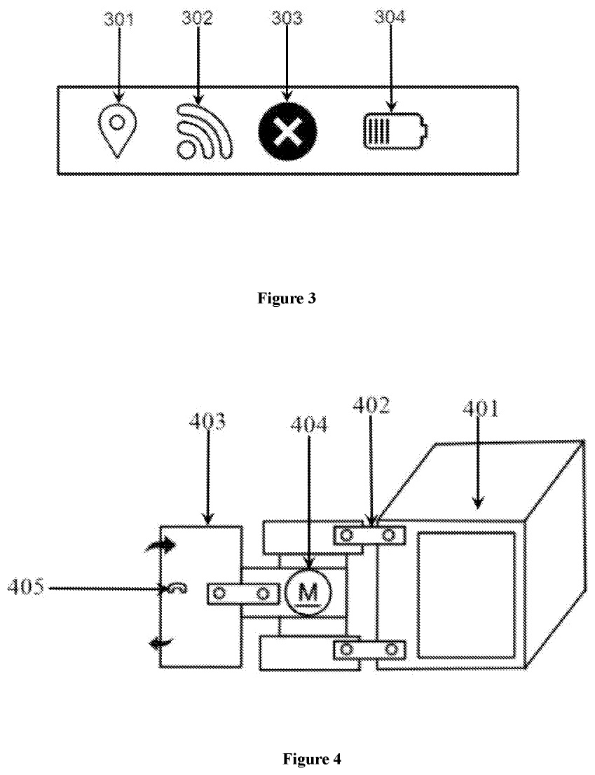

It is to be understood that digital display 105 displays, either continuously or intermittently, indicators corresponding to each of the plurality of sensors 109 and to the status of the power reserve of the power source 110, such as the indicator shown in FIG. 3. For example, an indicator corresponding to the GPS sensor would be activated upon system's detecting that container 101 has changed its location. An appropriate notification, both visual and audial, is generated by the system and transmitted to the user. One of the notifications is displayed on the digital display 105. Optionally, a second notification is transmitted to the user's other electronic device, e.g., computer, smartphone, and the like.

Similarly, indicators corresponding to the power reserve of the power source 110 sensor may be activated upon the system's detecting that power reserve of the power source 110 falls below a certain predetermined value. An appropriate notification, both visual and audial, is generated by the system and transmitted to the user. One of the notifications is displayed on the digital display 105. Optionally, a second notification is transmitted to the user's other electronic device, e.g., computer, smartphone, and the like.

Also, indicators may be provided corresponding to the sensor responsible for determining whether door 103 is closed and lock 102 in its locked position. A corresponding sensor may be activated upon system's detecting that door 103 is ajar or upon detecting that lock 102 in its unlocked position. An appropriate notification, both visual and audial, is generated by the system and transmitted to the user. One of the notifications is displayed on the digital display 105. Optionally, a second notification is transmitted to the user's other electronic device, e.g., computer, smartphone, and the like.

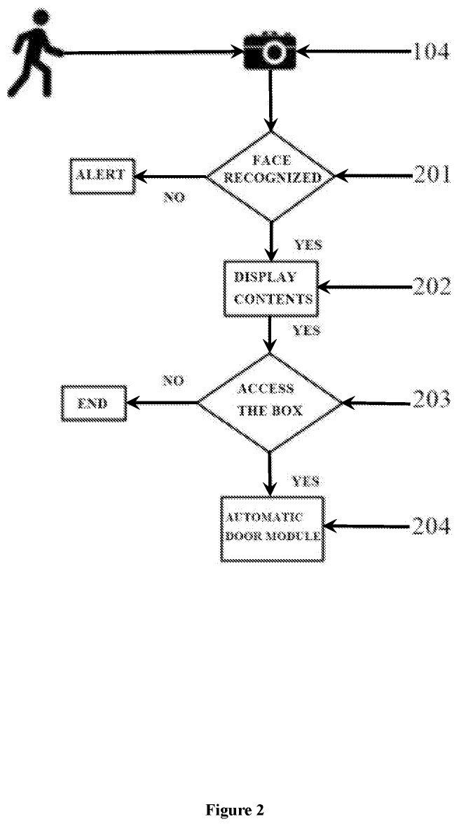

FIG. 2 depicts the flow chart of operation of the system with logical interconnection among various elements. As discussed herein, the process for accessing the smart box may begin with the user moving to be within the field of view of camera 104. Either automatically or manually, the camera 104 may capture an image of the user and the system may thereafter authenticate the user, which in one embodiment includes performing a face recognition analysis 204. If user authentication is positive, the content of the box may be displayed at the monitor or display screen 202. Thereafter, the user may be provided with an option to access the box 203, which if selected causes the automatic door module to unlock and/or open the door at 204.

Referring to FIG. 3, a set of indicators may be provided that display the status of the various sensors. For example, if the smart box 101 is moved from the defined location to another location, GPS status sensor 301 may be activated and the location details, like longitude and latitude, may be shared to a mobile application on a user device. As noted above, the location information may be used for authentication, for example to confirm that access to the device is not provided outside of a pre-set geographic area. Sensor status 303 is intended to indicate the status of the box whether it is open or close, the same information can be displayed on the display 105. Sensor status 302 facilitates the internet connection through wi-fi and other protocols. Along with these sensors, electric motors may be powered by the battery pack which is reflected in battery status indicator 304.

As depicted in FIG. 4, whenever a user tries to access the box, facial images will be captured and compared with stored data. Once the face recognition is successful and contents are made visible through display device or mobile application, the control will preferably be passed to the automatic door mechanism. The box frame 401 provides space to attach hub motor assembly 404 with a set of screws 402. Central part of motor assembly attached to the door 403 using screw or any other suitable joining means. Once the triggering signal is obtained from the edge processor, the motor will generate both clockwise and -anti clockwise torque to rotate the door to close and open the door accordingly. Other mechanical door mechanisms may be used to open and close the door automatically. Additionally, a handle 403 may be provided for manual mode operation.

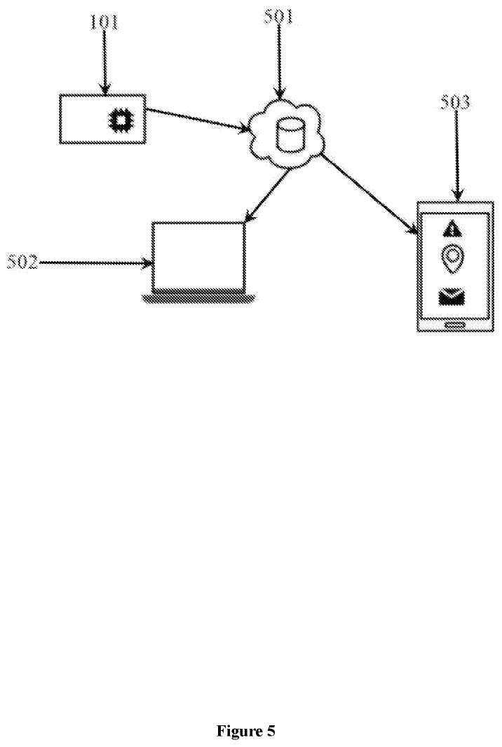

One aspect of the proposed invention is its ability to be operated remotely through a web application and/or mobile application. As depicted in FIG. 5, cloud database 501 contains the details of authorized users for the box 101, the same may be assessed by mobile application 503 and web application 502. Mobile applications preferably have a user interface to indicate the status, location, power level, etc. of the box. Mobile applications can also alert the user in case of tampering or physical damage, such as movement of the device, impact, etc., based on signals from accelerometers in or in association with the box. The mobile application may share the image or video information about the tempering scenario. Web & Mobile interface is preferably designed in such a way that the user can perform all the operations disclosed herein without any physical interaction with the box making it a fully touchless smart box.

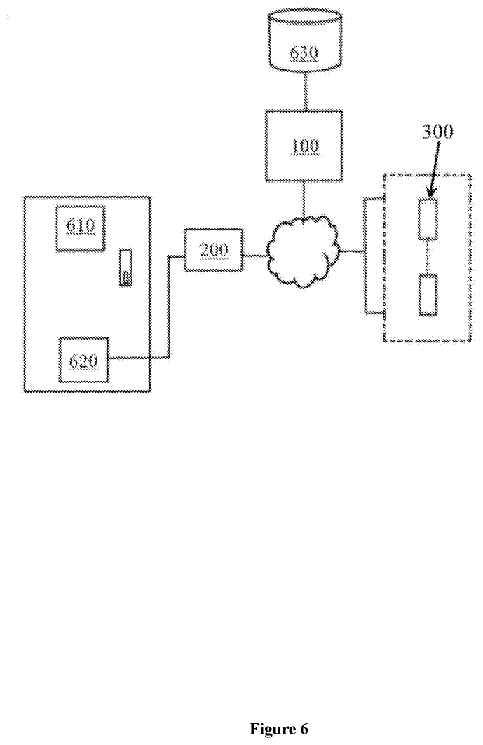

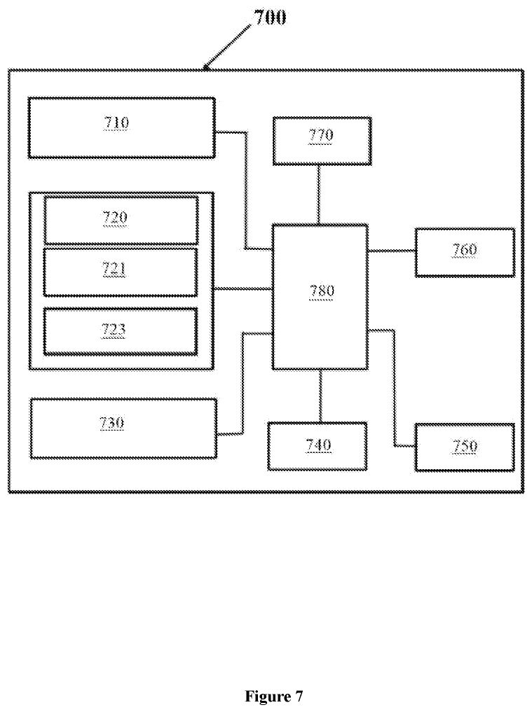

FIG. 6 is a view schematically showing a configuration for performing opening and closing control of an unattended storage box using face recognition according to an embodiment of the present invention. FIG. 7 is a view for explaining an unattended storage using face recognition according to an embodiment of the present invention. FIG. 7 is a block diagram showing the configuration of the opening or closing control device.

Referring to FIG. 6, a configuration of a system for performing an opening or closing control of an unattended storage box using facial recognition according to an embodiment of the present invention includes a management server 100, an opening or closing control device 200, and/or a terminal 300 of a distributor.

The management server 100 is associated with an authentication database (DB) 630 that including a plurality of face images for face authentication of a recipient or a sender. For example, the face image may be acquired using a camera (not shown) provided in the terminal 300 of the distributor or the recipient or may be acquired using the camera unit 620 provided during the initial opening of the device. In particular, the sender can register a face image for face authentication in the management server 100 by performing a registration procedure through a delivery-related application that can be installed on the sender's terminal 300 side. However, it goes without saying that the authentication DB 630 may be stored in a storage unit (not shown) of the switching control device 200, instead of the management server 100, in order to reduce the cost.

The opening and closing control device 200 may control the opening and closing of the unattended storage box using face recognition. However, it is needless to say that such an opening/closing control device 200 can control opening/closing of the door lock of the front door 103 through face recognition as a door lock configuration having a general face recognition function.

Referring to FIG. 7, the opening and closing control device 200/700 may include a camera unit 720, an authentication unit 750, a touch screen 730, a communication unit 760, a control unit 780, an illumination unit 710, a microphone 740, and/or a speaker 770.

The camera unit 720 is preferably configured to capture a face image of a delivery person performing delivery and includes an infrared camera 721 and a color camera 723, and simultaneously photographs a face image of a delivery person. The face image photographed by the infrared camera 721 is mainly used for face recognition, and the face image photographed by the color camera 723 is provided to the recipient terminal so that the recipient can be identified.

The illuminating unit 710 illuminates the illuminating face in the direction of the face so that the camera unit 720 can take a clearer image of the face image. Specifically, the illuminating unit 710 illuminates the illuminating unit 710 more favorably than the infrared camera 721 included in the camera unit 720 Infrared light can be projected in the face direction so that the face image can be captured.

The authentication unit 750 compares the photographed image photographed by the camera unit 720, particularly the infrared camera 721, with the face image stored in the authentication DB stored in the management server 100, thereby performing face authentication.

The touch screen 730 outputs the information output from the control unit 780. The touch screen 730 receives the input of a delivery person in a touch manner so that the delivery person can communicate with the recipient terminal.

For example, the touch screen 730 outputs a facial image of the delivery person output from the color camera 723 in the face authentication process, and when the face authentication fails, and displays a screen for transmission. At this time, the touch screen 730 can output a contact of the recipient terminal, select a corresponding contact to make a telephone connection, or input a character to the contact.

The communication unit 760 communicates with the recipient of the delivery through the wired/wireless communication network and receives an open or open rejection signal of the unattended storage 620 as an open control signal.

The control unit 780 controls the unattended storage 620 to open when the face image is authenticated or the open control signal is received from the recipient terminal.

The unattended storage 620 is configured to automatically lock when a predetermined time (e.g., about 10 seconds) is reached.

As another embodiment, an infrared temperature sensor (not shown) may be additionally provided inside the unattended storage box 620 as a safety configuration. If the infrared sensor detects the temperature of the person inside the opening/closing door (the result of the test is that the temperature of the person is measured at about 30 to 33 degrees), the opening/closing door of the unattended storage box 620 is immediately closed, can do.

The terminal 300 may be, but is not limited to, a mobile phone, a smart phone, a personal computer, a laptop, a netbook or a tablet, or a personal digital assistant (PDA).

Hereinafter, a method for controlling opening and closing of the unattended storage box using face recognition according to an embodiment of the present invention will be described.

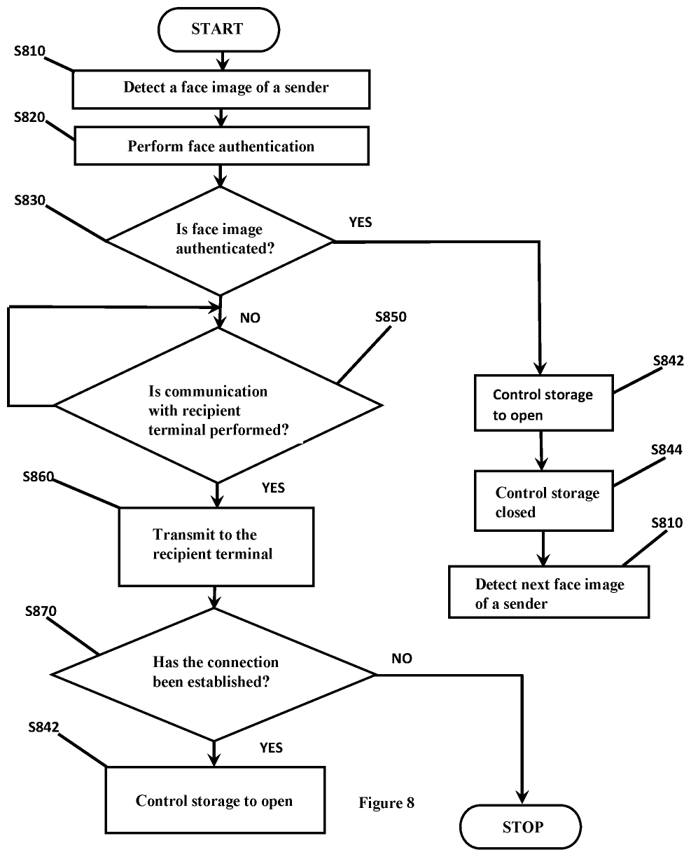

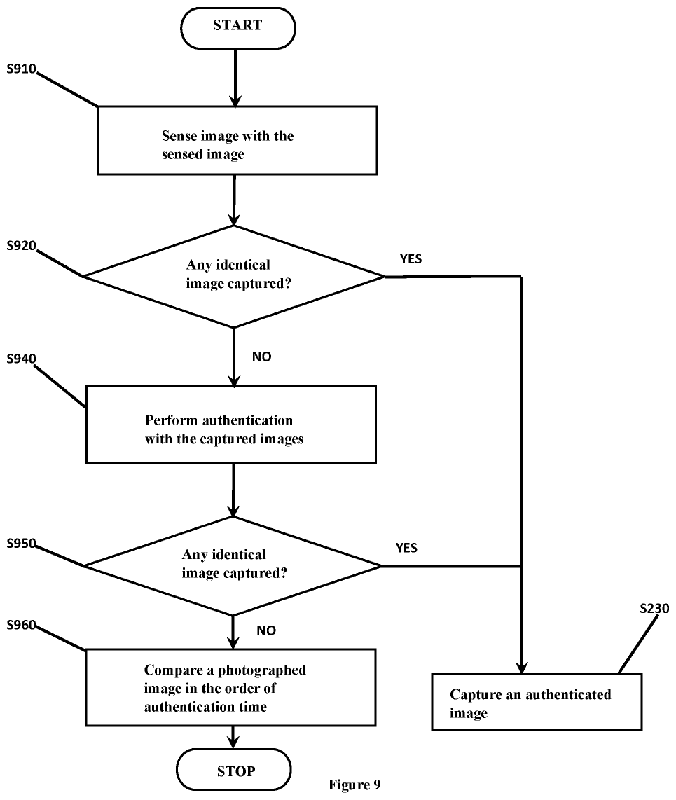

FIG. 8 is a flowchart illustrating a method for controlling opening and closing of an unattended storage box using face recognition according to an embodiment of the present invention. In particular, FIG. 8 focuses on the process of opening/closing the delivery person, that is, the courier, in the unattended storage box. Referring to FIG. 8, first, the camera unit 720 detects a face image of a sender (S810).

Next, the authentication unit 750 compares the photographed image photographed from the camera unit 720 with the face image stored in the authentication DB to perform face authentication (S820). At this time, the authentication unit can perform face authentication using the face image from the authentication DB 630 for face authentication stored in the remote management server 100.

When the face image is authenticated (S830), the control unit 780 controls the unattended storage 620 to be opened (S842). The automatic unlocking box 620 is automatically closed when a predetermined time elapses after the unattended storage box 620 is opened (S844). If the face image is not authenticated, the delivery person inputs the delivery person input through the touch screen 730 in a touch manner so that the delivery person can communicate with the recipient terminal (S850).

The touch screen 730 displays a screen for call connection or text transmission to the recipient terminal (S860). At this time, the touch screen 730 outputs the contact information of the recipient terminal, allows the sender to select a corresponding contact to make a telephone connection, or allows the sender to input a letter/message to the contact.

The communication unit 760 communicates with the receiver of the package and the receiver through the wired or wireless communication network to receive the open or open reject signal of the unattended storage 620 as an open control signal. If it is received, the unattended storage 20 is controlled to be opened (S842), and if not, it is ended.

FIG. 9 is a flowchart illustrating an authentication process according to an embodiment of the present invention.

Referring to FIG. 9, the authentication unit 750 performs authentication by comparing the face image of the time zone corresponding to the input time of the sensed image with the sensed image (S910).

Specifically, the authentication unit 750 takes a face image in a time zone corresponding to the input time of the captured image captured from the camera unit 720, among the face images stored in the authentication DB 630 for each time period, It can be compared with the image.

For this purpose, the authentication DB 630 may be composed of a database in which facial images for authentication are classified and stored for a plurality of predetermined time zones, and the authentication required time is stored. Here, the plurality of time zones may be, for example, 24 hours divided by 2 to N intervals, and the user may arbitrarily adjust the time zones. The time required for authentication means the time taken for the photographed image to be used for face recognition and to complete the authentication.

The authentication DB 630 may store the face image itself or may extract and store only the characteristic information used for face recognition and may store both the face image itself and the feature information extracted therefrom.

The configuration of the authentication DB 630 allows the authentication unit 750 to expect an improved authentication rate and an authentication rate when performing authentication. Next, it is determined whether there is an identical image (S920). If there is no matching image, the authentication is performed by comparing the captured image with the captured image in the order of the face images having the fastest authentication time (S940).

Next, it is again determined whether there is an identical image (S950). If there is no matching image even when the facial image and the photographed image are compared in the order of authentication required time, the authentication result is output (S960). If there is an identical image in steps 5220 and 5250, the authentication unit 750 outputs an authentication result indicating that the authentication is successful (S930).

A subsequent process such as controlling the opening and closing of the unattended storage box 620 of the authentication unit 750 can be performed. On the other hand, the courier recipient who receives the actual courier basically receives the courier service by inputting the password key or opening or closing the unattended storage box by face authentication.

In the case where the courier recipient controls the opening and closing of the unattended storage box through the face authentication, the same authentication process is performed as in the process of opening and closing the unattended storage box, that is, the courier article mentioned above.

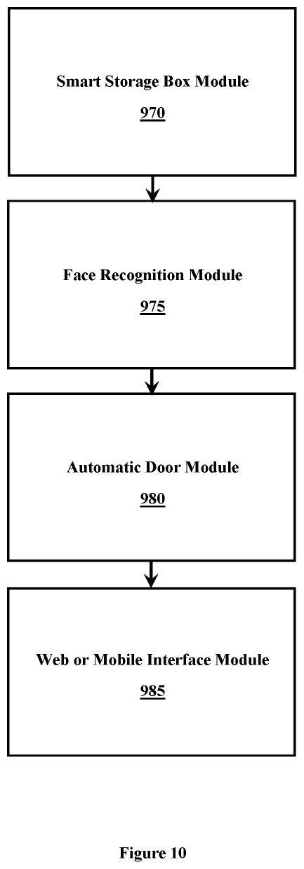

Referring to FIG. 10 is a block diagram illustrating one of an implementation of the present invention. The implementation of an integrated system comprises a touchless smart storage box module (970), a face recognition module (975), an automatic door module (980) and a web or mobile interface module (985). The box module (970) comprises multiple sensors and communication protocol such as wireless fidelity (Wi-Fi), near-field-communication (NFC), Bluetooth, general packet radio service (GPRS) and mobile connectivity through subscriber identification module (SIM) card for remote control and for sending alerts. The box module (975) is also embedded with a baroscopic camera with LED lights.

The face recognition module (975) includes an edge camera communicatively connected to a processor storing a facial recognition algorithm with features like spoof detection. The face recognition module (975) interacts with cloud databases for web and mobile interaction.

The automatic door opening module (980) includes an electric hub motor supported in a circular cylinder for autonomous opening and closing operation of the door of the box module (970). It is to be understood that the automatic door opening model may comprise other mechanisms and elements that are configured to open or/and close the door of the box module (970).

The web or mobile interface module (985) includes a computer program, which, when executed, enables remote operation of the box module (970).

While the invention has been shown and described with reference to certain preferred embodiments thereof, it will be understood by those skilled in the art that various changes and modifications may be made without departing from the spirit and scope of the invention. Accordingly, the scope of the present invention should not be limited by the illustrated embodiments, but should be determined by equivalents of the claims and the claims.

What is claimed is:

1. A storage system, comprising:
a compartment having an opening and a door for selectively accessing the compartment, the door operable between an open and a closed positions;
a lock for selectively locking the door;
a display device;
an externally facing camera;
an internally facing camera; and
a processor coupled to a memory, the memory storing software code that when executed causes the processor to capture an image of a user with the externally facing camera, authenticate the user against a plurality of authentication images; and upon positively authenticating the user, capture an image of content of the compartment and display the content of the compartment on the display.

2. The system of claim 1, wherein the display device is disposed of on an outward facing side of the door.

3. The system of claim 1, comprising at least one sensor that determines whether the door is in either the open and closed positions and a close/open indicator that indicates a status of the compartment with respect to being one of open and close.

4. The system of claim 1, comprising a communication module.

5. The system of claim 1, the processor further operable to display the image captured with the external camera when the user reaches the compartment.

6. The system of claim 1, the processor further operable to lock and unlock the lock in response to positive authentication.

7. The system of claim 1, the processor further operable to open and close the door automatically in response to positive authentication.

8. The system of claim 1, the processor further operable to alert an authorized user of a failed authentication.

9. The system of claim 1, the processor further operable to open and close the door automatically in response to positive authentication, and to close the door automatically when the user moves out of a field of view of the external camera.

10. The system of claim 1, the processor further operable to open and close the door automatically in response to positive authentication and in response to a signal from the user to open or close the door.

11. A method for controlling opening and closing of an unmanned storage box, the storage box comprising a compartment having an opening and a door for selectively accessing the compartment, the door operable between an open and a closed positions; a lock for selectively locking the door; a display device; an externally facing camera; an internally facing camera; and a processor coupled to a memory, the memory storing software code that when executed causes the processor to perform certain functions, the method comprising:
capturing an image of a user with the externally facing camera,
authenticating the user against a plurality of authentication images; and
upon positively authenticating the user, capturing an image of content of the compartment and displaying the content of the compartment on the display .

12. The method of claim 11, the method further comprising enabling a courier to communicate with a recipient terminal when authentication fails.

13. The method of claim 11, the storage box further comprising a communication unit, the method comprising communicating with a receiver using the communication unit.

14. The method of claim 13, wherein the receiver communicates through a wired or wireless communication network, the method comprising receiving an open or open reject signal by the unattended storage from the receiver and using the signal to at least one of unlock and open the door.

15. The method of claim 11, further comprising the step of controlling a control unit to open the unmanned storage box when receiving an open control signal from a recipient terminal.

16. The method of claim 11, wherein the display device is disposed of on an outward facing side of the door.

17. The method of claim 11, comprising displaying by the processor the image captured with the external camera when the user reaches the compartment.

18. The method of claim 11, comprising locking and unlocking by the processor the lock in response to positive authentication.

19. The method of claim 11, comprising opening and closing by the processor the door automatically in response to positive authentication.

20. The method of claim 11, the processor further operable to open and close the door automatically in response to positive authentication, and closing by the processor the door automatically when the user moves out of a field of view of the external camera.
